(19) United States
(12) Patent Application Publication
(10) Pub. No.: US 2026/0341028 A1
(43) Pub. Date: Oct. 29, 2026

(54) WEATHER INFORMATION PROVIDING SYSTEM, WEATHER INFORMATION PROVIDING METHOD, AND WEATHER INFORMATION PROVIDING PROGRAM

(71) Applicant: FURUNO ELECTRIC CO., LTD., Nishinomiya-City (JP)

(72) Inventor: Yuya TAKASHIMA, Nishinomiya (JP)

(73) Assignee: FURUNO ELECTRIC CO., LTD., Nishinomiya-City (JP)

(21) Appl. No.: 19/704,915

(22) Filed: Jun. 11, 2026

Related U.S. Application Data
(63) Continuation of application No. PCT/JP2024/002858, filed on Jan. 30, 2024.

(51) Int. Cl. G06V 20/52; G01W 1/10; G06T 7/50; G06T 7/73; G06T 11/23

(52) U.S. Cl. CPC G06V 20/52; G01W 1/10; G06T 7/50; G06T 7/74; G06T 11/23; G06T 2207/20072; G06T 2207/30192; G06T 2207/30232; G06V 2201/07

(57) ABSTRACT

A weather information providing system includes processing circuitry. The processing circuitry acquires a first image including one or more target objects taken in a first direction from a first known location. Further, the processing circuitry calculates a distance between the first known location and the one or more target objects. Further, the processing circuitry determines whether the one or more target objects in the first image is recognizable from the first known location. Further, the processing circuitry generates a plurality of contour lines from a recognizable target object, to form a plurality of vectors. The processing circuitry generates a heat map from the plurality of vectors and estimate a source position of smog from the heat map.

### CROSS-REFERENCE TO RELATED APPLICATION

This application is a continuation application of PCT International Application No. PCT/JP2024/002858, which was filed on Jan. 30, 2024, the entire disclosure of which is hereby incorporated by reference.

### TECHNICAL FIELD

The present invention relates to a weather information providing system and a method to evaluate visibility in multiple directions.

### BACKGROUND

Adequacy of visibility holds paramount importance for ensuring safety of aviation operations. Insufficient visibility poses a direct risk to a pilot's visual perception, and inaccurate assessments of airport visibility specifically during landing operations and take off operations. Such insufficient visibility adversely impacts flight operations, leading to escalated maintenance expenditures for airlines, and the potential for catastrophic aviation incidents. Consequently, the precise forecasting of visibility conditions at airport runways has evolved into a critical concern that demands unwavering attention from the aviation industry.

Extensive analysis of factors influencing visibility reveals a substantial correlation between atmospheric visibility and meteorological parameters such as humidity, wind speed, and various weather phenomena, including fog, precipitation, and dust. During visual aircraft operations, alterations to the designated landing site become imperative in response to hazardous weather conditions characterized by poor visibility, such as smog. Such necessity is particularly pronounced in regions where the incidence rate and concentration of smog are elevated, necessitating a flexible approach to the adjustment of landing sites.

Therefore, there is a need for an improved system and method that facilitates the selection of landing site by showing the concentration distribution of smog.

### SUMMARY

A first aspect of the invention relates to a weather information providing system. The weather information providing system includes processing circuitry. The processing circuitry acquires a first image including one or more target objects taken in a first direction from a first known location. Further, the processing circuitry calculates a distance between the first known location and the one or more target objects. The processing circuitry determines whether the one or more target objects in the first image is recognizable from the first known location.

According to the first aspect, the processing circuitry may generate a plurality of contour lines from a recognizable target object, to form a plurality of vectors, generate a heat map from a plurality of vectors, and estimate a source position of smog from the heat map on a user interface.

According to the first aspect, the processing circuitry may generate a 360-degree view from the first image in the first direction. The processing circuitry may determine the one or more target object taken in the first direction from the first known location in the first image. The processing circuitry may mark the one or more target objects in the first image.

According to the first aspect, the processing circuitry may calculate the distance between the first known location and the one or more target objects based on a map data.

According to the first aspect, the processing circuitry may determine a range of vision from the recognizable target objects from the first known location among the one or more target objects. The processing circuitry may map the one or more target objects recognizable on the map data.

According to the first aspect, the processing circuitry may remove an unrecognized target objects on the map data. The processing circuitry may generate a plurality of contour lines from the recognizable target objects from the first known location among the one or more target objects. The processing circuitry may generate the plurality of contour lines by enlarging from the first known location.

According to the first aspect, the processing circuitry may determine a density zone distribution from the plurality of contour lines and generate the heat map from the density zone distribution.

According to the processing circuitry of the first aspect, the density zone distribution includes of the plurality of contour lines near to the first known location is mapped as high density zone. The plurality of contour lines far from the first known location is mapped as low density zone. Further, the processing circuitry may map a density zone distribution from the plurality of contour lines in two-dimensional map data with latitude on a vertical axis and longitude on a horizontal axis.

According to the first aspect, the processing circuitry may generate the plurality of vectors from a direction of the low density zone to a direction of the high density zone. The processing circuitry may map the source position of smog from the plurality of vectors.

According to the first aspect, the processing circuitry may acquire a wind information. The processing circuitry may estimate a change in the heat map based on the wind information. The processing circuitry may predict the source position of smog from change in the wind information in the heat map over time.

A second aspect of present invention relates to a method for weather information providing system. The method comprising of acquiring a first image including one or more target objects taken in a first direction from a first known location. The method comprising of calculating a distance between the first known location and the one or more target objects. The method comprising of determining whether the one or more target objects in the first image is recognizable from the first known location.

According to the second aspect, the method comprising of mapping a plurality of recognizable target objects on a map data. The method comprising of generating a plurality of contour lines from the recognizable target objects from the first known location among the one or more target objects on the map data. The method comprising of determining a density zone distribution from the plurality of contour lines. The method comprising of generating a heat map from the density zone distribution.

According to the second aspect, the method comprising of generating a plurality of vectors from a direction of a low density zone to a direction of a high density zone in the density zone distribution. The method comprising of estimating a source position of smog from the plurality of vectors on the heat map.

A third aspect of the present invention relates to a program or a non-transitory computer readable medium for storing instruction which when are executed by processing circuitry causes the processing circuitry to acquire a first image including the one or more target objects taken in the first direction from the first known location, calculate a distance between the first known location and the one or more target objects, determine whether the one or more target objects in the first image is recognizable from the first known location, generate a heat map from the plurality of vectors, and estimate a source position of smog from the heat map.

As described above, according to the present invention, a weather information providing system, a method for weather information providing system, and a program that can perform operations with accuracy to map smog concentration can be provided.

The effect or significance of the present invention will be further clarified by the following description of the embodiment. However, the following embodiment is only one example when implementing the present invention, and the present invention is not in any way limited to those described in the following embodiment.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 illustrates a block diagram of a weather information providing system (100), according to an embodiment of the present invention.

FIG. 2 illustrates a perspective view of the weather information providing system (100), according to an embodiment of the present invention.

FIG. 3 illustrates an exemplary image showing a mapping of a recognizable target object and an unrecognizable target object, according to an embodiment of the present invention.

FIGS. 4(A)-4(B) illustrate contour lines on the image of FIG. 3, according to an embodiment of the present invention.

FIG. 5 illustrates a density zone distribution from a plurality of contour lines of FIGS. 4(A)-4(B), according to an embodiment of the present invention.

FIG. 6 illustrates another exemplary image showing a vector from the density zone distribution, according to an embodiment of the present invention.

FIG. 7 illustrates a heat map from the plurality of vectors of FIG. 6, according to an embodiment of the present invention.

FIGS. 8(A)-8(B) illustrate a flowchart showing steps of a weather information providing system (100), according to an embodiment of the present invention.

### DETAILED DESCRIPTION

Embodiments of the present invention will be described below with reference to the drawings. The same reference numerals are given to the same or corresponding parts in the figure, and the description thereof will not be repeated. At least some of the embodiments described below may be arbitrarily combined.

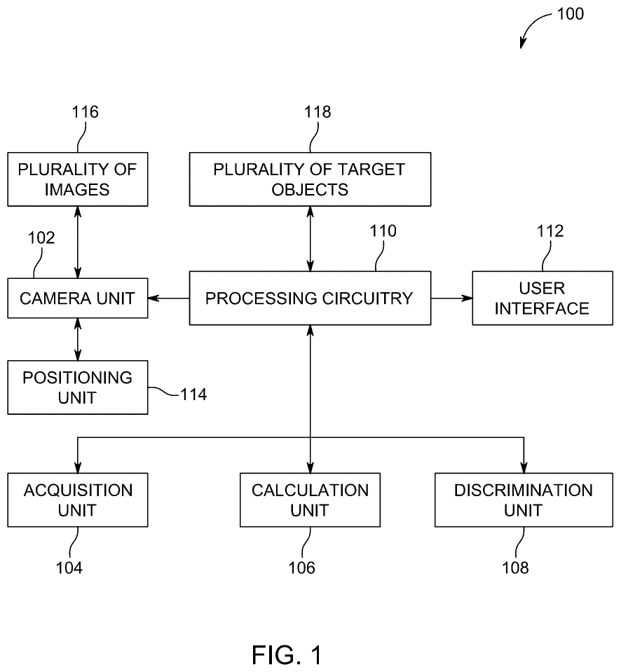

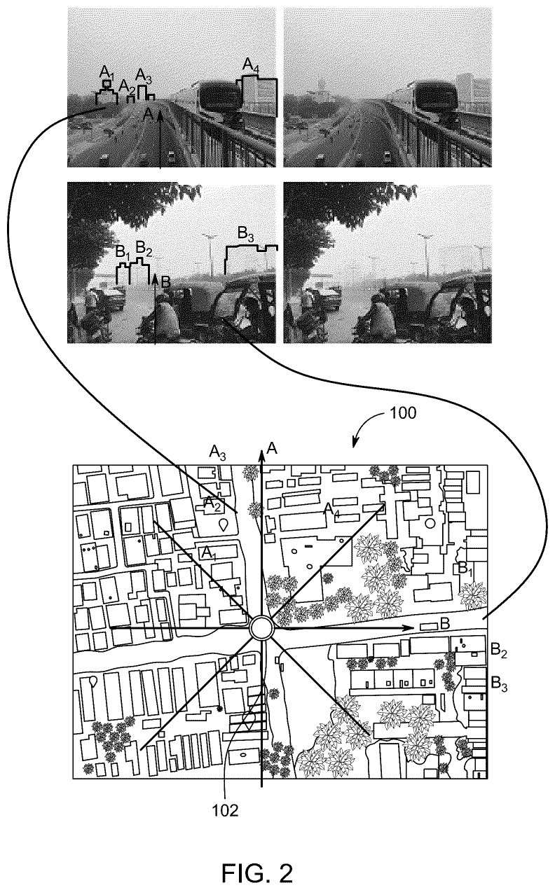

FIG. 1 illustrates a block diagram of a weather information providing system (100), according to an embodiment of the present invention. FIG. 2 illustrates a perspective view of the weather information providing system (100), according to an embodiment of the present invention.

The weather information providing system (100) may comprise a camera unit (102), an acquisition unit (104), a calculation unit (106), a discrimination unit (108), processing circuitry (110), and a user interface (112). (The acquisition unit (104), the calculation unit (106), and the discrimination unit (108) may be implemented as part of the processing circuitry.) In various examples, the weather information providing system (100) may also be referred as a smog concentration mapping system.

The camera unit (102) may be equipped with a positioning unit (114). In some example embodiments, the positioning unit (114) may be a Global Positioning System (GPS), a Global Navigation System (GLONASS), a BeiDou, and Galileo satellites. The camera unit (102) may be installed at a first known location. In various examples, the camera unit (102) may include a camera (not shown) that may be configured to capture a plurality of images (116). The camera unit (102) may be configured to capture a first image in a first direction from a first known location. It may be noted that the plurality of images (116) may be referred as the first image (116) and vice-versa. The first image (116) may include one or more target objects or a plurality of target objects (118) in the first direction from the first known location. In various example embodiments, the camera unit (102) is installed on centre of a crossroad, as illustrated in FIG. 2. The camera unit (102) may be configured to capture the first image (116) from the first know location. The first image (116) includes the one or more target objects (118). In various examples, the one or more target objects (118) may be distant buildings, a tower or a statue, etc.

The acquisition unit (104) may be configured to acquire the first image (116) including the one or more target objects (118) taken in the first direction from the first known location. The acquisition unit (104) may be configured to acquire the first image (116) captured by the camera unit (102). Further, the acquisition unit (104) may be configured to generate a 360-degree view from the first image (116) in the first direction. Further, the acquisition unit (104) may be configured to determine the one or more target objects (118) taken in the first direction from the first known location in the first image (116). Successively, the acquisition unit (104) may mark the one or more target objects (118) in the first image (116). For example, the one or more target objects (118) may be marked in an alphabetical order, in a numerical order, or the combination of alphabet and number.

The calculation unit (106) may be configured to calculate a distance between the first known location and the one or more target objects (118) based on a map data. In various examples, the map data may include the coordinates of the one or more target objects (118). The first known location may be used as a centre for the one or more target objects (118). In some embodiments, the calculation unit (106) may be configured to arrange the one or more target objects (118) taken in the first direction from the first known location in the first image (116), in a vertical axis A and a horizontal axis B, as illustrated in FIG. 2. In some embodiments, the vertical axis A may comprise the one or more target objects (118) as A1, A2, A3, A4, etc., and the horizontal axis B may comprise the one or more target objects (118) as B1, B2, B3 etc.

Further, the discrimination unit (108) may be configured to determine whether the one or more target objects (118) in the first image (116) may be recognizable from the first known location. In some embodiments, a target object in an image captured by the camera unit (102) may not be recognizable from the crossroad, i.e., the first known location. In this case, the acquisition unit (104) may acquire another image from the first image (116) captured by the camera unit (102). The discrimination unit (108) may be configured to map the one or more target objects (118) that may be recognizable on the map data.

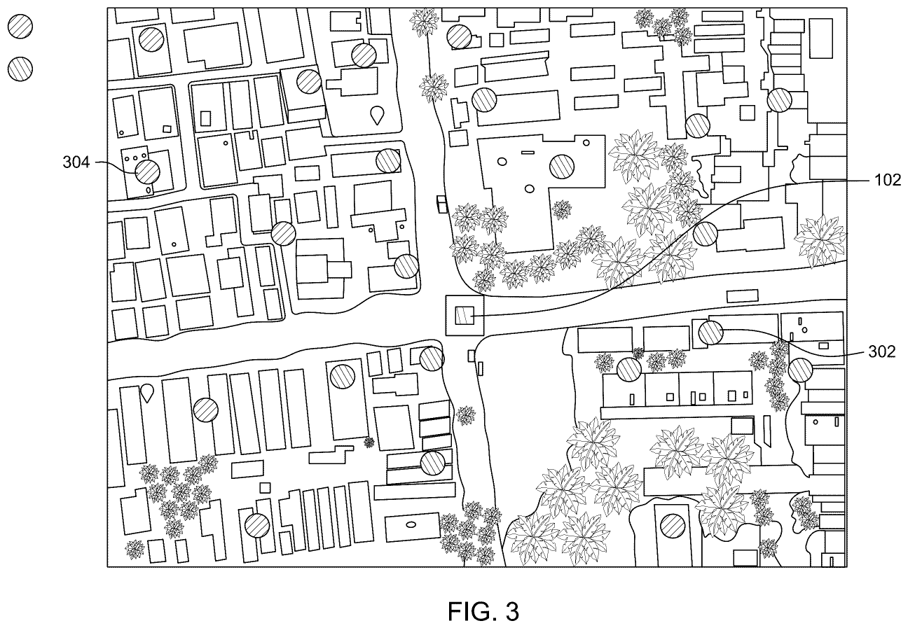

Further, the processing circuitry (110) is communicatively coupled to the acquisition unit (104), the calculation unit (106), and the discrimination unit (108). The processing circuitry (110) may be configured to generate a heat map and estimate a source position of smog from the heat map to display on the user interface (112). In some embodiments, the user interface (112) may include a display device such as, a mobile phone, a computer system, a portable computer system, and other electronic display devices, without departing from the scope of the disclosure. The operation of the processing circuitry (110) is described in conjunction with FIGS. 3-7.

FIG. 3 illustrates an exemplary image (300) showing a mapping of a recognizable target object (302) and an unrecognizable target object (304), according to an embodiment of the present invention. FIG. 3 is described in conjunction with FIGS. 1-2.

The map data may have the recognizable target object (302) and the unrecognizable target object (304). As discussed earlier, the discrimination unit (108) may be configured to determine a range of vision from the recognizable target object (302) from the first known location among the one or more target objects (118). The discrimination unit (108) may mark the unrecognized target object (304) on the map data. In various embodiments, the recognizable target object (302) and the unrecognizable target object (304), may be color coded on the map data. The recognizable target object (302) may be present near to the first know location. The unrecognizable target object (304) may be present far from the first know location.

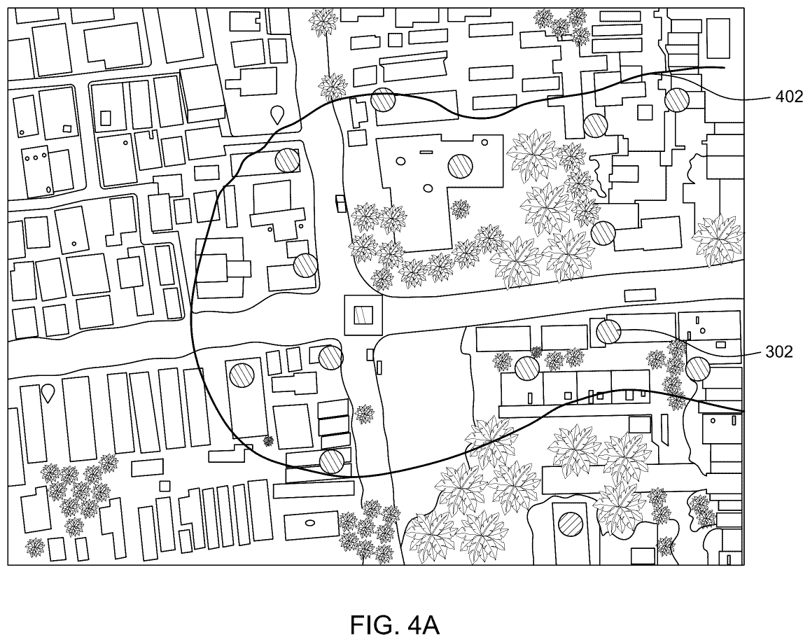

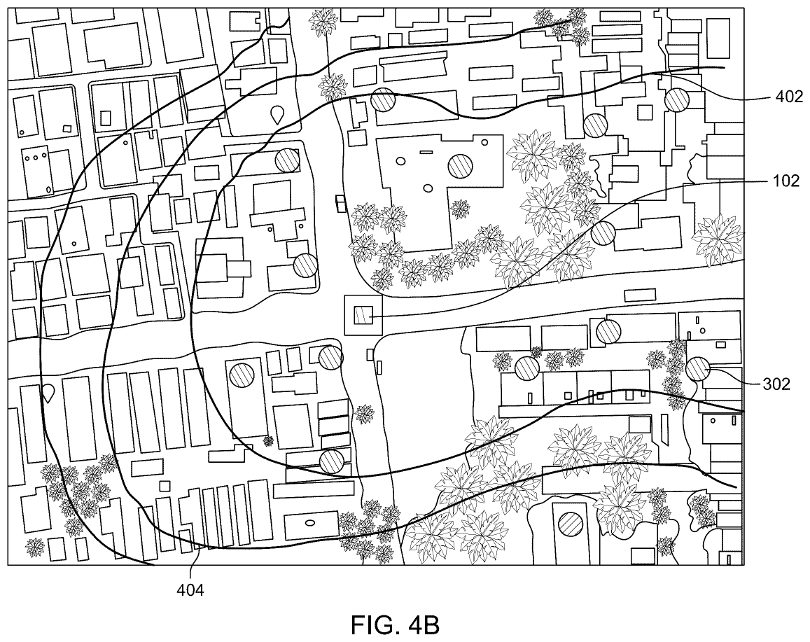

FIGS. 4(A)-4(B) illustrate contour lines, according to an embodiment of the present invention. FIGS. 4(A)-4(B) is described in conjunction with FIG. 3.

The processing circuitry (110) may be configured to remove the unrecognizable target object (304) and keep the recognizable target object (302), on the map data. The processing circuitry (110) may be configured to generate a first contour line (402) from the recognizable target object (302) from the first known location among the one or more target objects (118). The first contour line (402) may be referred as an inner contour line. In some embodiments, subsequent contour lines may be generated by the processing circuitry (110) moving farther from the first contour line (402), as shown in FIG. 4(B).

As illustrated in FIG. 4(B), the processing circuitry (110) may generate a plurality of contour lines (404) by enlarging from the first known location. Successively, the processing circuitry (110) may be configured to map the plurality of contour lines (404) on the map data. In some example embodiments, the plurality of contour lines (404) may include the first contour line (402) and the subsequent contour lines towards an outer region from the first contour line (402). Further, the first contour line (402) may be configured to include all recognizable target objects (302). It may be noted that the first contour line (402) may be drawn by combining the farthest recognizable target object (302) from the first know location. The first contour line (402) may create an inner contour line profile, and the subsequent contour lines are drawn from the inner contour line profile.

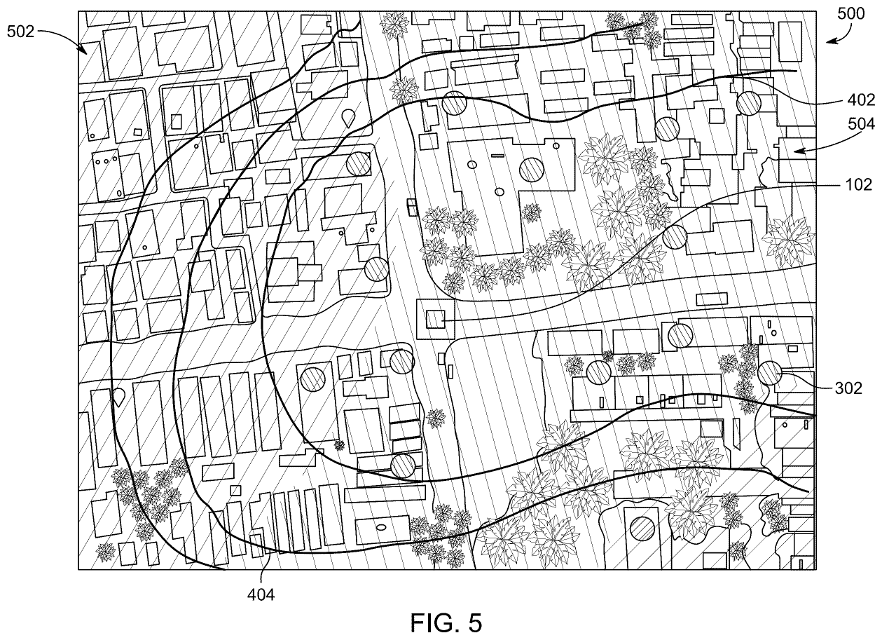

FIG. 5 illustrates a density zone distribution (500) from the plurality of contour lines (404) of FIGS. 4(A)-4(B), according to an embodiment of the present invention.

The processing circuitry (110) may be configured to determine the density zone distribution (500) from the plurality of contour lines (404). In some embodiments, the density zone distribution (500) may comprise a high density zone (502) and a low density zone (504). The plurality of contour lines (404) near to the first known location may be assigned as the low density zone (504). The plurality of contour lines far from the first known location may be assigned as the high density zone (502). In some embodiments, the processing circuitry (110) may be configured to map the density zone distribution (500) from the plurality of contour lines in two-dimensional map data with latitude on a vertical axis and longitude on a horizontal axis. Further, the processing circuitry (110) may be configured to generate a heat map from the density zone distribution (500). It may be noted that the heat map may be color coded. For example, the high density may be color coded as red. The low density zone (504) may be color coded as green.

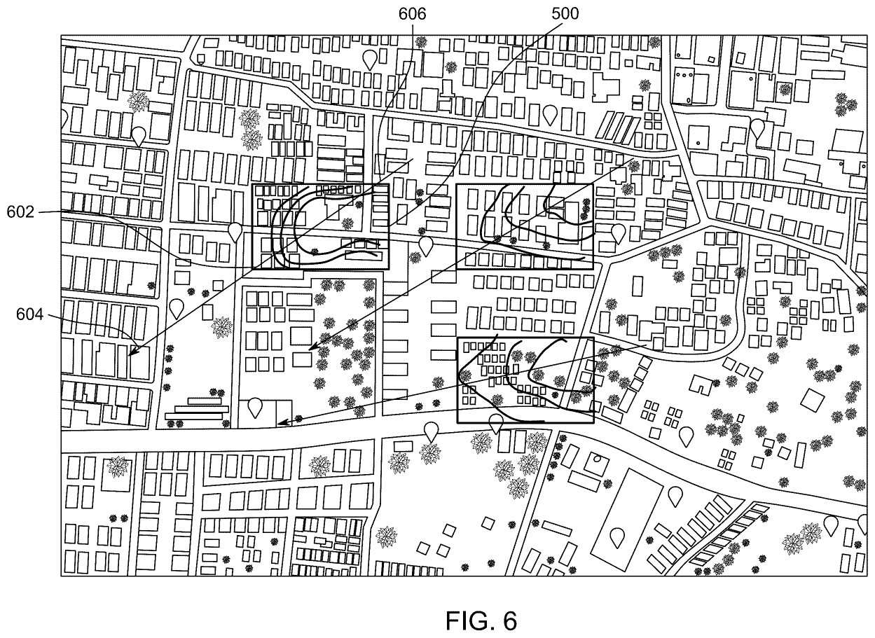

FIG. 6 illustrates another exemplary image showing a plurality of vectors (602) from the density zone distribution (500), according to an embodiment of the present invention.

The processing circuitry (110) may be configured to generate the plurality of vectors (602) from a direction of the low density zone (504) to a direction of the high density zone (502) within the density zone distribution (500). A vector head (604) may be configured to point towards the high density zone (502), and a vector tail (606) may be configured to point towards the low density zone (504). In some embodiments, the low density zone (504) may include the recognizable target object (302) farthest from the first known location within the first contour line (402). In some embodiments, the high density zone (502) may include the recognizable target object (302) near the first known location with respect to the first contour line (402). It may be noted that the recognizable target object (302) may need to be on the first contour line (402).

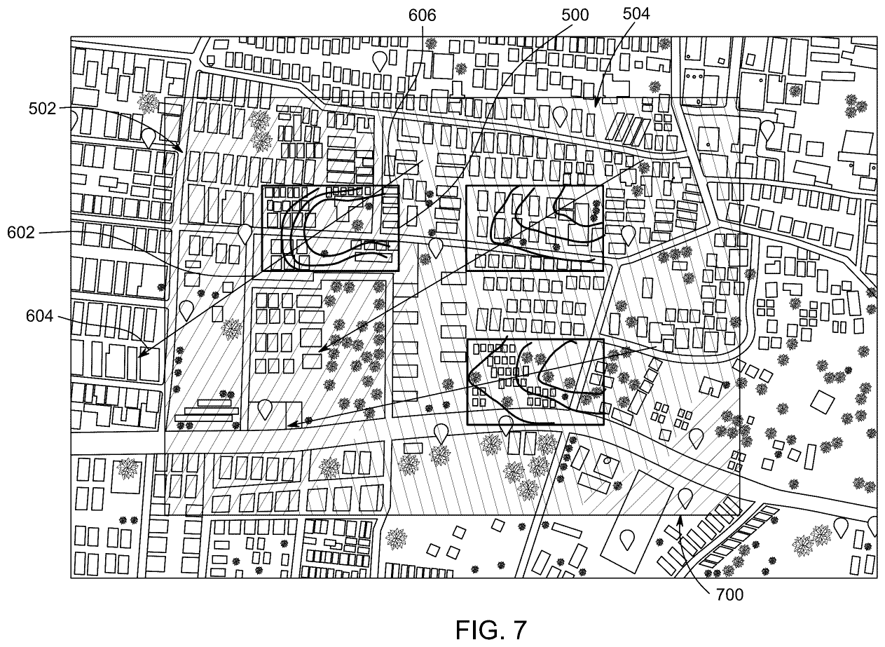

FIG. 7 illustrates a heat map (700) from the plurality of vectors (602), according to an embodiment of the present invention. FIG. 7 is described in conjunction with FIG. 6.

The processing circuitry (110) may be configured to generate the heat map (700) from the plurality of vectors (602). The plurality of vectors (602) may be represented as the direction in which smog may be thinnest as the low density zone (504) to the direction in which the smog may be darkest or thick as the high density zone (502). It may be noted that the heat map (700) may be color coded. For example, the high density zone (502) may color coded as red. The low density zone (504) may be color coded as green. The processing circuitry (110) may be configured to estimate or map source position of smog from the generated heat map (700).

In some other embodiments, the processing circuitry (110) may be configured to acquire a wind information. The wind information may be acquired data using an application programming interface (API) from 3^{rd} party servers, e.g., weather forecasting systems. It may be noted that the wind may be configured to change direction based on the climatic condition. The change in the wind direction may be configured to change the density zone of the smog in the high density zone (502) and the low density zone (504). The processing circuitry (110) may be configured to estimate a change in the heat map (700) based on the wind information. Successively, the processing circuitry (110) may be configured to predict the source position of smog from change in the wind information in the heat map (700) over time.

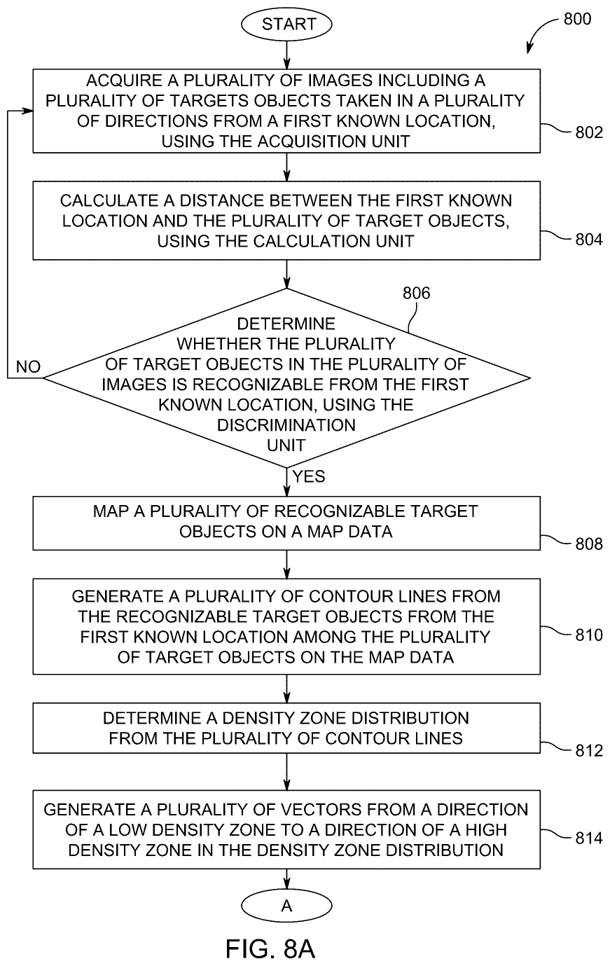

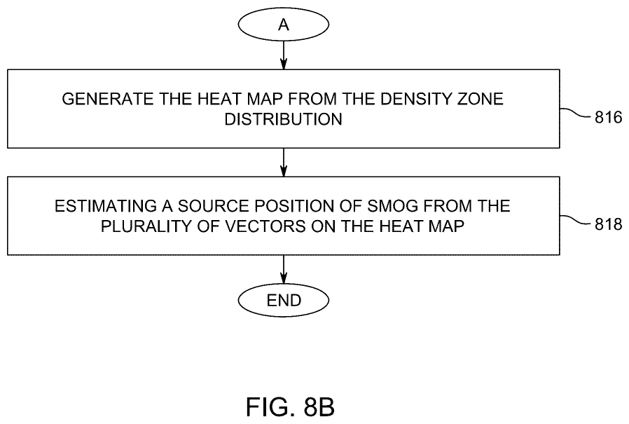

FIGS. 8(A)-8(B) illustrate a flowchart showing steps of a smog concentration mapping method (800), according to an embodiment of the present invention. FIGS. 8(A)-8(B) are described in conjunction with FIGS. 1-7.

The acquisition unit (104) acquires the first image (116) including the one or more target objects taken in the first direction from the first known location, at step (S802). This steps corresponds to FIG. 2 which describes that the camera unit (102) is installed on the crossroad and it captures images in all directions. The images captured include target objects, i.e., buildings, towers, trees, etc., and these images are acquired by the acquisition unit (104).

Further, the calculation unit (106) calculates the distance between the first known location and the one or more target objects, at step (S804). This step corresponds to FIG. 2 and FIG. 3, which describe that the first know location, e.g., the crossroad, and the calculation unit (106) calculates the distance between a target object, e.g., a building from the first known location, i.e., the crossroad.

Successively, the discrimination unit (108) determines whether the one or more target objects in the first image (116) is recognizable from the first known location, at step (S806). This step corresponds to target objects illustrated in FIGS. 2-3. The discrimination unit (108) in one case may determine, based on the first image (116) acquired by the acquisition unit (104), that the one or more target objects (118) are not recognizable from the first known location, e.g., the crossroads. The discrimination unit (108) in this case, may be redirected back to step (S802) where the acquisition unit (104) may be acquiring the first image (116) from the camera unit (102). Further, the discrimination unit (108) in other case, may determine, based on the first image (116) acquired by the acquisition unit (104), that the one or more target objects (118) are recognizable from the first known location, e.g., the crossroads. The discrimination unit (108) in this case may proceed to map the plurality of recognizable target objects (302) on a map data, at step (S808). As illustrated in FIG. 3, the plurality of recognizable target objects (302) are mapped or pin-pointed based on their recognition in the first image (116).

Successively, the processing circuitry (110) may generate the plurality of contour lines (404) around the recognizable target object (302) of the one or more target objects (118) from the first known location on the map data, at step (S810). This step corresponds to FIGS. 4(A)-4(B), where contour lines are drawn around the recognizable target object (302) in form of a map. The processing circuitry (110) may remove unrecognized target points from the map.

Successively, the processing circuitry (110) may determine a density zone distribution from the plurality of contour lines (404), at step (S812). This step corresponds to FIG. 5, that illustrates the density zone distribution. The plurality of contour lines (404) may establish a density distribution of the two-dimensional data distribution with latitude on the vertical axis and longitude on the horizontal axis that may be mathematically calculated. The density distribution of smog may be obtained by simply enlarging the plurality of contour lines (404) with respect to the position of the camera unit (102) and setting some of them as a gradually high-density distribution. Also, a first calculated contour shows the density distribution of the lowest density smog.

Successively, the processing circuitry (110) may generate the plurality of vectors (602) from the direction of the low density zone (504) to the direction of the high density zone (502) in the density zone distribution, at step (S814). This step corresponds to the plurality of vectors (602), illustrated in FIGS. 2 and 6. As illustrated in FIG. 2, a first image may be taken along the horizontal axis A or a first direction and a second image taken along the vertical axis B or in the second direction and based on that a vector may be created from the direction of the thinnest smog to the direction of the densest smog at each point, and the direction of a composite vector is the direction of the dense smog.

Successively, the processing circuitry (110) may generate the heat map (700) from the density zone distribution, at step (S816). The heat map (700), as illustrated in FIG. 7, may represent that the density of smog may be drawn by heat map representation from the density distribution of smog. Further, in a boundary between the vertical axis B and the horizontal axis A, the distance from the camera unit (102) may be taken out from the recognizable target object (302), and the density distribution may be calculated as a map of the range up to the distance centre on position of the camera unit (102), so that the relative shading may be easily expressed.

Thereafter, the processing circuitry (110) may estimate a source position of smog from the plurality of vectors (602) on the heat map on the user interface (112), at step (S818). The processing circuitry (110) may estimate meteorological environmental factors from the plurality of vectors (602) on the heat map (700). Additionally, while smog is mentioned as an example of meteorological environmental factors, other factors that can affect visibility such as pollen, fog, localized rain, snow, haze, dust storms, falling ash, air pollution, pollen dispersal and steam may also be applicable.

As discussed earlier, the processing circuitry (110) may be configured to acquire a wind information. In some embodiments, the wind information may include wind speed and wind direction. The wind information may be acquired data using an application programming interface (API) from 3^{rd} party servers, e.g., weather forecasting systems. The processing circuitry (110) may be configured to create future heat map or predict the source position of weather environmental factors based on the wind information. Successively, the processing circuitry (110) may be configured to create multiple heat maps at different times. Further, the processing circuitry (110) may create future heat map or predict the source position of weather environmental factors based on changes in the heat map over time.

In some alternate embodiments, a non-transitory computer readable medium storing instruction which when are executed by processing circuitry causes the processing circuitry to perform numerous functions, is disclosed. The processing circuitry is configured to acquire a first image (116) including the one or more target objects (118) taken in the first direction from the first known location, using the acquisition unit (104). The processing circuitry is configured to calculate a distance between the first known location and the one or more target objects (118), using the calculation unit (106). The processing circuitry is configured to determine whether the one or more target objects (118) in the first image (116) is recognizable from the first known location, using the discrimination unit (108). The processing circuitry (110) may be configured to generate the plurality of contour lines (404) from a recognizable target object (302), to form the plurality of vectors (602). The processing circuitry is configured to generate the heat map (700) from the plurality of vectors. The processing circuitry is configured to estimate a source position of smog from the heat map (700) on the user interface (112).

The above embodiments are exemplary in all respects and are not restrictive. The scope of the invention is set forth in the claims, not in the above description, and includes the meaning of and all variations within the scope of the claims.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this invention. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by processing circuitry. The processing circuitry may be a microprocessor, but in the alternative, the processing circuitry may be a controller, microcontroller, or state machine, combinations of the same, or the like. The processing circuitry is configured to process computer-executable instructions. In another embodiment, a processor includes an application specific integrated circuit (ASIC), a field programmable gate array (FPGA) or other programmable device that performs logic operations without processing computer-executable instructions. The processing circuitry may also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, the processing circuitry may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey those certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any embodiment.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

It should be emphasized that many variations and modifications may be made to the above-described embodiments, the elements of which are to be understood as being among other acceptable examples. All such modifications and variations are intended to be included herein within the scope of this invention and protected by the following claims.

What is claimed is:

1. A weather information providing system, comprising:
processing circuitry configured to:
acquire a first image including one or more target objects within a field of view taken in a first direction from a first known location;
calculate a distance between the first known location and the one or more target objects; and
determine whether the one or more target objects in the first image is recognizable from the first known location.

2. The weather information providing system of claim 1, wherein the processing circuitry is further configured to:
generate a 360-degree view from the first image in the first direction;
determine the one or more target objects taken in the first direction from the first known location in the first image; and
mark the one or more target objects in the first image.

3. The weather information providing system of claim 1, wherein the processing circuitry is further configured to:
calculate the distance between the first known location and the one or more target objects based on a map data.

4. The weather information providing system of claim 1, wherein the processing circuitry is further configured to:
determine a range of vision from the recognizable target object from the first known location among the one or more target objects; and
map the one or more target objects recognizable on the map data.

5. The weather information providing system of claim 1, wherein the processing circuitry is further configured to:
generate a plurality of contour lines from a recognizable target object, to form a plurality of vectors;
generate a heat map from the plurality of vectors; and
estimate a source position of a meteorological environmental factor from the heat map on a user interface.

6. The weather information providing system of claim 3, wherein the processing circuitry is further configured to:
remove an unrecognized target object on the map data; and
generate the plurality of contour lines from the recognizable target object from the first known location among the one or more target objects.

7. The weather information providing system of claim 5, wherein the processing circuitry is further configured to:
determine a density zone distribution from the plurality of contour lines; and
generate the heat map from the density zone distribution.

8. The weather information providing system of claim 7, wherein the density zone distribution comprises of:
the plurality of contour lines near to the first known location is assigned as high density zone; and
the plurality of contour lines far from the first known location is assigned as low density zone.

9. The weather information providing system of claim 7, wherein the processing circuitry is further configured to:
map the density zone distribution from the plurality of contour lines in two-dimensional map data with latitude on a vertical axis and longitude on a horizontal axis.

10. The weather information providing system of claim 8, wherein the processing circuitry is further configured to:
generate the plurality of vectors from a direction of the low density zone to a direction of the high density zone; and
map the source position of the meteorological environmental factor from the plurality of vectors.

11. The weather information providing system of claim 10, wherein the processing circuitry is further configured to:
acquire a wind information;
estimate a change in the heat map based on the wind information; and
predict the source position of the meteorological environmental factor from change in the wind information in the heat map over time.

12. A non-transitory computer readable medium for storing instruction which when executed by processing circuitry causes the processing circuitry to:
acquire a first image including one or more target objects taken in a first direction from a first known location;
calculate a distance between the first known location and the one or more target objects; and
determine whether the one or more target objects in the first image is recognizable from the first known location.

13. A method for weather information providing system, the method comprising:
acquiring a first image including one or more target objects taken in a first direction from a first known location;
calculating a distance between the first known location and the one or more target objects; and
determining whether the one or more target objects in the first image is recognizable from the first known location.

14. The method of claim 13, further comprising:
mapping a recognizable target object on a map data;
generating a plurality of contour lines from the recognizable target object from the first known location among the one or more target objects on the map data;
determining a density zone distribution from the plurality of contour lines; and
generating a heat map from the density zone distribution.

15. The method of claim 13, further comprising:
generating a plurality of vectors from a direction of a low-density zone to a direction of a high density zone in the density zone distribution; and
estimating a source position of meteorological environmental factors from the plurality of vectors on the heat map.
